(19) United States
(12) Patent Application Publication
(10) Pub. No.: US 2019/0248149 A1
(43) Pub. Date: Aug. 15, 2019

(54) LIQUID CIRCULATION DEVICE AND LIQUID DISCHARGE DEVICE

(71) Applicant: TOSHIBA TEC KABUSHIKI KAISHA, Tokyo (JP)

(72) Inventor: Tetsuya Sato, Yokohama Kanagawa (JP)

(21) Appl. No.: 16/271,972

(22) Filed: Feb. 11, 2019

(30) Foreign Application Priority Data
Feb. 15, 2018 (JP) 2018-024646

(51) Int. Cl. B41J 2/175; B41J 2/18

(52) U.S. Cl. CPC B41J 2/17596; B41J 2/18

(57) ABSTRACT

In accordance with an embodiment, a liquid circulation device comprises a first flow pipe; a first pump arranged in the first flow pipe; a first diameter expansion portion, arranged in the first flow pipe on a secondary side of the first pump, configured to have a larger cross sectional area than that of the first flow pipe; a second flow pipe; a second pump arranged in the second flow pipe; and a second diameter expansion portion, arranged in the second flow pipe on a primary side of the second pump, configured to have a larger cross sectional area than that of the second flow pipe.

### CROSS-REFERENCE TO RELATED APPLICATION

This application is based upon and claims the benefit of priority from Japanese Patent Application No. P2018-024646, filed on Feb. 15, 2018 the entire contents of which are incorporated herein by reference.

### FIELD

Embodiments described herein relate generally to a liquid circulation device and a liquid discharge device.

### BACKGROUND

A conventional inkjet recording apparatus comprises an ink circulation device for circulating ink and discharges ink from a liquid discharge head onto an image receiving medium such as a paper sheet. Since such an ink circulation device is relatively large, miniaturization is required. However, generally, in order to miniaturize the ink circulation device, a new configuration and complicated operations are required, and thus, a configuration of the ink circulation device becomes burdensome. For example, if the ink circulation device is miniaturized due to integration of respective components or the like, there is a possibility that the device or component thereof becomes difficult to repair. If the miniaturization is desired, there is also a problem that the inkjet recording apparatus is difficult to accommodate a plurality of ink circulation devices for circulating plural kinds of ink.

### DESCRIPTION OF THE DRAWINGS

FIG. 1 is a perspective view illustrating a configuration of an inkjet recording apparatus according to a first embodiment;

FIG. 2 is a schematic diagram illustrating the configuration of the inkjet recording apparatus;

FIG. 3 is a block diagram illustrating the configuration of the inkjet recording apparatus;

FIG. 4 is a perspective view illustrating a configuration of an inkjet recording apparatus according to a second embodiment;

FIG. 5 is a schematic diagram illustrating the configuration of the inkjet recording apparatus;

FIG. 6 is a perspective view illustrating a configuration of an inkjet recording apparatus according to a third embodiment;

FIG. 7 is a schematic diagram illustrating a configuration of an inkjet recording apparatus according to a fourth embodiment; and

FIG. 8 is a schematic diagram illustrating a configuration of an inkjet recording apparatus according to a fifth embodiment.

### DETAILED DESCRIPTION

In accordance with an embodiment, a liquid circulation device comprises a first flow pipe; a first pump arranged in the first flow pipe; a first diameter expansion portion, arranged in the first flow pipe on a secondary side of the first pump, configured to have a larger cross sectional area than that of the first flow pipe; a second flow pipe; a second pump arranged in the second flow pipe; and a second diameter expansion portion, arranged in the second flow pipe on a primary side of the second pump, configured to have a larger cross sectional area than that of the second flow pipe.

### First Embodiment

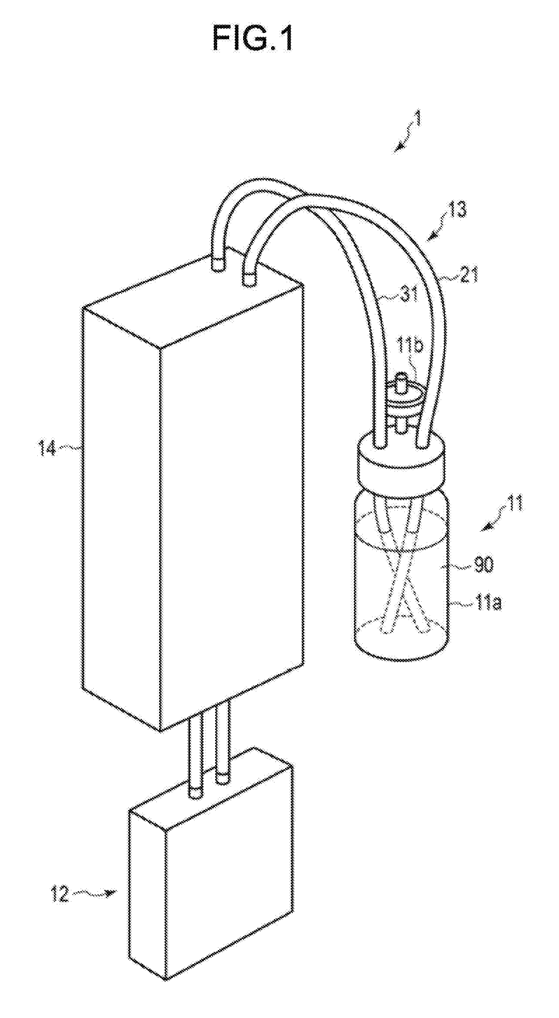

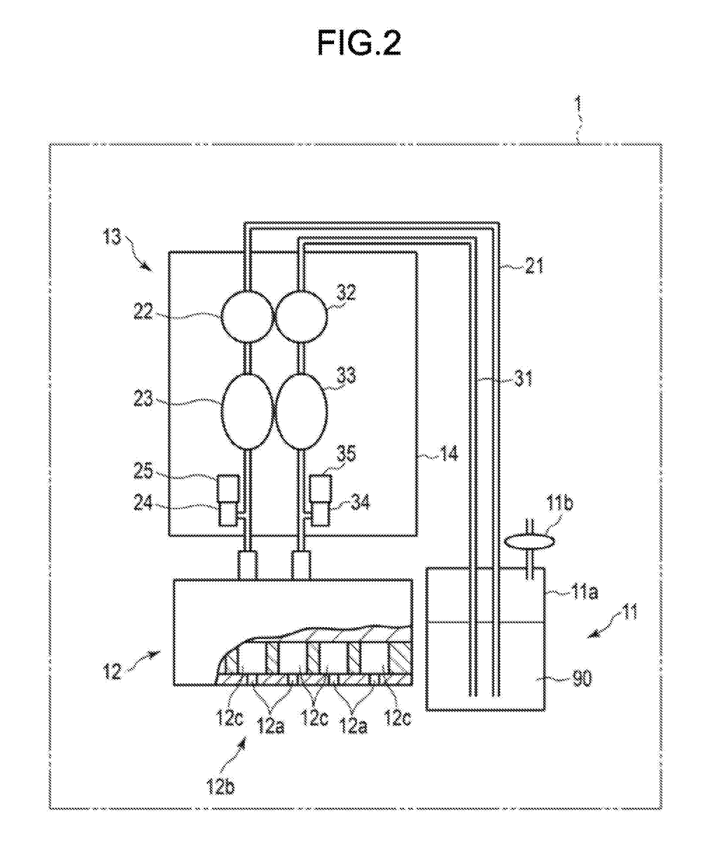

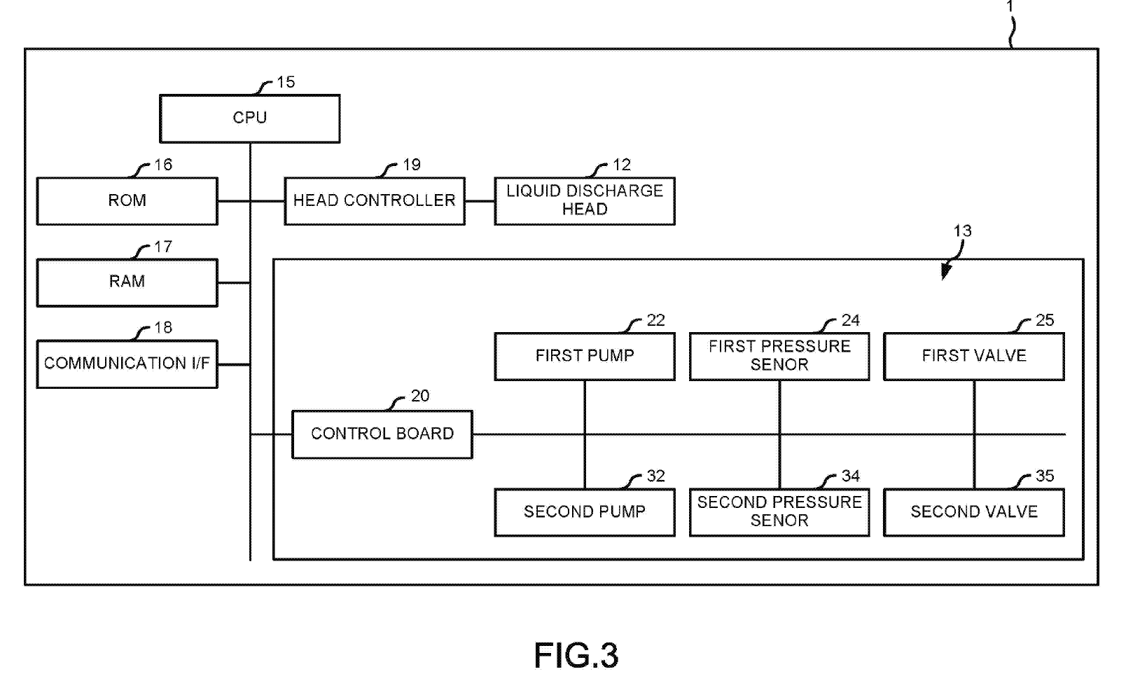

Below, an inkjet recording apparatus (liquid discharge device) 1 using an ink circulation device (liquid circulation device) 13 according to a first embodiment is described with reference to FIG. 1 to FIG. 3.

The inkjet recording apparatus 1 includes one or a plurality of tanks 11, a liquid discharge head 12, an ink circulation device 13 for circulating ink (liquid) 90 between the tank 11 and the liquid discharge head 12, a casing 14 for accommodating the ink circulation device 13, a CPU (Central Processing Unit) 15, a ROM (Read Only Memory) 16, a RAM (Random Access Memory) 17, a communication I/F (Interface) 18, a head controller 19 and a control board 20.

The number of tanks 11 is the same as the number of types of the ink 90 discharged by the inkjet recording apparatus 1. Here, the type of the ink 90 is classified according to a color, characteristic, etc. of the ink 90. In the present embodiment, since the inkjet recording apparatus 1 that discharges the ink 90 in one color is used, one tank 11 is provided. For example, the tank 11 filled with the ink 90 is mounted in the ink circulation device 13. The tank 11 may be a repeatedly usable container that can be replenished with the ink 90 when a remaining amount of the ink 90 is low, or may be a disposable container that is replaced with a container filled with the ink 90 when the remaining amount of the ink 90 therein is low.

The tank 11 includes a tank body 11a and an air filter 11b provided in the tank body 11a. The tank body 11a communicates with the atmosphere via the air filter 11b.

The liquid discharge head 12 discharges the ink 90 in one color or two colors. In the present embodiment, since the inkjet recording apparatus 1 discharges the ink 90 in one color, the liquid discharge head 12 discharges the ink 90 in one color. The liquid discharge head 12 has one or a plurality of nozzle rows 12b in which a plurality of nozzle holes 12a is arranged in one direction. In the liquid discharge head 12, for example, a plurality of pressure chambers 12c of an actuator including a piezoelectric element and a vibration plate is arranged to face a nozzle plate having the nozzle row 12b, and by driving the actuator, the ink 90 in the pressure chamber 12c is discharged onto the image receiving medium from the nozzle hole 12a facing the pressure chamber 12c.

The liquid discharge head 12 includes an ink flow path for supplying the ink 90 to each pressure chamber 12c, a supply port provided on the primary side of the ink flow path and a discharge port arranged at the secondary side of the ink flow path. One or a plurality of sets composed of the supply port and the discharge port is provided in accordance with the number of nozzle holes 12a or the number of nozzle rows 12b. For example, the liquid discharge head 12 is arranged in a posture in which a plurality of nozzle holes 12a is opened downwards in the direction of gravity.

The ink circulation device 13 includes a first flow pipe 21, a first pump 22, a first diameter expansion portion 23, a first pressure sensor 24, a first valve 25, a second flow pipe 31, a second pump 32, a second diameter expansion portion 33, a second pressure sensor 34 and a second valve 35.

A primary side of the first flow pipe 21 is connected to the tank 11, and a secondary side thereof is connected to a supply port of the liquid discharge head 12. The first flow path pipe 21 is, for example, a tube made of resin material. The first flow pipe 21 is constituted by a plurality of tubes having a predetermined length, for example, and the tube can be connected to each component by a so-called pipe connection.

The first pump 22 is, for example, a diaphragm pump. The first pump 22 supplies the ink 90 in the tank 11 to the liquid discharge head 12.

The first diameter expansion portion 23 is provided on the secondary side of the first pump 22. An area of a cross section of the first diameter expansion portion 23 that is orthogonal to a flow direction of the ink 90 is larger than that of a cross section of the first flow pipe 21 that is orthogonal to the flow direction of the ink 90, and the first diameter expansion portion 23 has a predetermined length in the flow direction of the ink 90. Specifically, the first diameter expansion portion 23 constitutes a liquid chamber having a larger cross sectional area than that of the first flow pipe 21 between the first pump 22 and the liquid discharge head 12 to reduce a pulsation of the ink 90 that is discharged from the first pump 22 on the primary side and supplied from the first flow pipe 21 to the liquid discharge head 12. The liquid chamber constituted by the first diameter expansion portion 23 may have a columnar shape, a rectangular columnar shape, or other shapes as long as it can reduce the pulsation of the ink 90. For example, the first diameter expansion portion 23 is arranged side by side with the first pump 22 along the direction of gravity.

The first pressure sensor 24 is provided in the first flow pipe 21 on the secondary side of the first diameter expansion portion 23. The first pressure sensor 24 detects the pressure of the ink 90 in the first flow pipe 21 on the secondary side of the first diameter expansion portion 23.

The first valve 25 is provided in the first flow pipe 21 on the secondary side of the first diameter expansion portion 23. For example, the first valve 25 is provided on the primary side of the first pressure sensor 24. The first valve 25 is an electromagnetic valve that opens and closes the flow path of the first flow path pipe 21 on the secondary side of the first diameter expansion section 23. The first valve 25 is a pressure adjustment mechanism that is opened or closed to adjust the pressure in the first flow pipe 21.

A primary side of the second flow pipe 31 is connected to the liquid discharge head 12, and a secondary side thereof is connected to the tank 11. The second flow pipe 31 is, for example, a tube made of resin material. For example, the second flow pipe 31 includes a plurality of tubes formed to have a predetermined length, and the tube can be connected to each component by a so-called pipe connection.

The second pump 32 is, for example, a diaphragm pump. The second pump 32 returns the ink 90 that flows through the ink flow path in the liquid discharge head 12 and is not discharged from the liquid discharge head 12 to the tank 11.

The second diameter expansion portion 33 is provided on the primary side of the second pump 32. An area of a cross section of the second diameter expansion portion 33 that is orthogonal to a flow direction of the ink 90 is larger than that of a cross section of the second flow pipe 31 that is orthogonal to the flow direction of the ink 90, and the second diameter expansion portion 33 has a predetermined length in the flow direction of the ink 90. Specifically, the second diameter expansion portion 33 constitutes a liquid chamber having a larger cross sectional area than that of the second flow pipe 31 between the second pump 32 and the liquid discharge head 12 to reduce a pulsation of the ink 90 that is discharged from the liquid discharge head 12 and is sucked by the second pump 32 on the secondary side. The liquid chamber constituted by the second diameter expansion portion 33 may have a columnar shape, a rectangular columnar shape, or other shapes as long as it can reduce the pulsation of the ink 90. For example, the second diameter expansion portion 33 is arranged side by side with the second pump 32 along the direction of gravity.

The second pressure sensor 34 is provided in the second flow pipe 31 on the secondary side of the liquid discharge head 12 and on the primary side of the second diameter expansion portion 33. The second pressure sensor 34 detects the pressure of the ink 90 in the second flow pipe 31 on the secondary side of the liquid discharge head 12 and on the primary side of the second diameter expansion portion 33.

The second valve 35 is provided in the second flow pipe 31 on the secondary side of the liquid discharge head 12 and on the primary side of the second diameter expansion portion 33. The second valve 35 is provided, for example, on the secondary side of the second pressure sensor 34. The second valve 35 is a solenoid valve that opens and closes the flow path of the second flow pipe 31 on the secondary side of the second diameter expansion portion 33. The second valve 35 is a pressure adjustment mechanism that is opened or closed to adjust the pressure in the second flow pipe 31.

The casing 14 has, for example, a rectangular parallelepiped shape in which an accommodation space of a predetermined volume is arranged. The casing 14 accommodates configurations of the first flow pipe 21 and the second flow pipe 31 of the ink circulation device 13 except for portions thereof at both end sides connected to the tank 11 and the liquid discharge head 12.

The accommodation space in the casing 14 has a volume capable of accommodating the two ink circulation devices 13. Specifically, the accommodation space in the casing 14 has a volume capable of accommodating the double of each of a part of the first flow pipe 21, the first pump 22, the first diameter expansion portion 23, the first pressure sensor 24, the first valve 25, a part of the second flow pipe 31, the second pump 32, the second diameter expansion portion 33, the second pressure sensor 34 and the second valve 35.

In the present embodiment, since the casing 14 is the inkjet recording apparatus 1 that discharges the ink 90 of one color, in the accommodation space of the casing 14 in which two ink circulation devices 13 can be accommodated, a part of the first flow pipe 21, one first pump 22, one first diameter expansion section 23, one first pressure sensor 24, one first valve 25, a part of the second flow pipe 31, one second pump 32, one second diameter expansion portion 33, one second pressure sensor 34 and one second valve 35 are accommodated.

The CPU 15 controls the entire inkjet recording apparatus 1. The CPU 15 executes various programs to execute various processing. The CPU 15 is electrically connected to the ROM 16, the RAM 17, the communication I/F 18, the head controller 19, and the control board 20 in the inkjet recording apparatus 1. The CPU 15 outputs an operation instruction to each section of the inkjet recording apparatus 1 in response to an operation command from an external device and notifies the external device of various kinds of information acquired from each section.

The ROM 16 is a non-rewritable nonvolatile memory for storing programs, control data and the like. The RAM 17 is a volatile memory. The RAM is, for example, a working memory.

Specifically, the CPU 15 uses the RAM 17 and executes programs stored in the ROM 16 to execute various processing.

The communication I/F 18 is used for communicating with an external device. For example, the communication I/F 18 receives print data in response to a printing request from the external device. The communication I/F 18 is electrically connected to the CPU 15 to constitute an interface for transmitting and receiving data to and from the external device.

The head controller 19 drives the liquid discharge head 12 based on an instruction from the CPU 15. The head controller 19 is electrically connected to a drive circuit of the liquid discharge head 12.

For example, the control board 20 is accommodated in the casing 14 and is electrically connected to the first pump 22, the first pressure sensor 24, the first valve 25, the second pump 32, the second pressure sensor 34 and the second valve 35. The control board 20 receives signals including pressure value transmitted from the first pressure sensor 24 and the second pressure sensor 34, and performs control to drive the first pump 22, the first valve 25, the second pump 32 and the second valve 35.

According to the inkjet recording apparatus 1 configured as described above, on the secondary side of the first pump 22 of the ink circulation device 13 and on the primary side of the second pump 32, the first diameter expansion portion 23 and the second diameter expansion portion 33 are provided to reduce the pulsation of the ink 90. With this configuration, the ink circulation device 13 can reduce the pulsation of the ink 90 supplied from the first pump 22 to the liquid discharge head 12 and the ink 90 supplied from the liquid discharge head 12 to the second pump 32. Specifically, the first diameter expansion portion and the second diameter expansion portion 33 reduce pulsation on the primary side and the secondary side of the liquid discharge head 12.

Therefore, the ink circulation device 13 controls the first pump 22 and the second pump 32 according to the pressure of the ink 90 on the secondary side of the first pump 22 and on the primary side of the second pump 32 to adjust the pressure in the nozzle hole 12a of the liquid discharge head 12. The ink circulation device 13 can prevent the ink 90 from dripping from the nozzle hole 12a due to the pulsation and also prevent the air from being sucked from the nozzle hole 12a.

As a result, the ink circulation device 13 does not need to adjust the pressure of the ink 90 in the nozzle hole 12a of the liquid discharge head 12 using the hydraulic head pressure, and thus, plural tanks or complicate operations or configurations are not required, and the configuration can be simplified.

The first pump 22 and the second pump 32 each may be a thin and small-sized diaphragm pump as long as it can provide necessary pressure to the secondary side. Since the first valve 25 and the second valve 35 each may be a small-sized and commercially available inexpensive valve as a pressure adjustment mechanism as long as it can open and close the flow path. Therefore, even if the casing 14 accommodating the ink circulation device 13 has a width of 83 mm, a height of 142 mm, and a thickness of 40.5 mm, for example, the casing 14 can accommodate the two ink circulation devices 13, and a space necessary for accommodating the ink circulation device 13 of the inkjet recording apparatus 1 can be reduced. The casing 14 is formed into a shape capable of accommodating the two ink circulation devices 13, and in this way, it is possible to deal with both the case in which one ink circulation device 13 is used and the case in which two ink circulation devices 13 are used, and the components can be shared, thereby reducing the manufacturing cost.

Since complicated operations and configurations are not required, the first pump 22, the first valve 25, the second pump 32, and the second valve 35 can be controlled in a simple manner. As a result, the control board 20 can be miniaturized, and the manufacturing cost can be reduced as well.

As a result, the ink circulation device 13 and the inkjet recording device 1 can be miniaturized and can be manufactured at low cost as compared with the prior art. It is possible to reduce the number of components and also to simplify the configuration without requiring integrated components and the like, and thus, the maintenance becomes easy.

As described above, according to the inkjet recording apparatus 1 using the ink circulation apparatus 13 according to the first embodiment, by providing the first diameter expansion portion 23 and the second diameter expansion portion 33 for reducing the pulsation on the secondary side of the first pump 22 and on the primary side of the second pump 32, it is possible to realize miniaturization with a simple structure.

### Second Embodiment

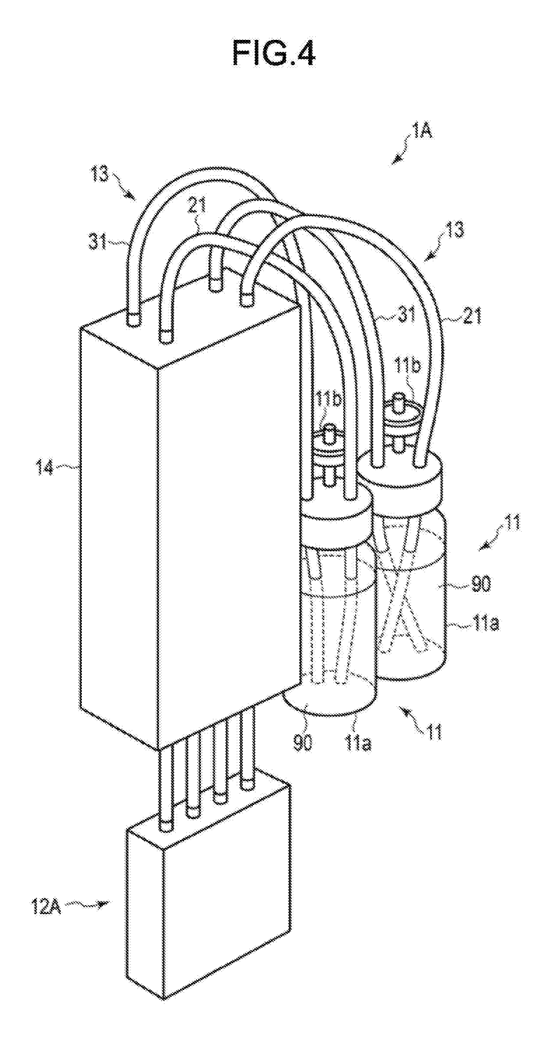

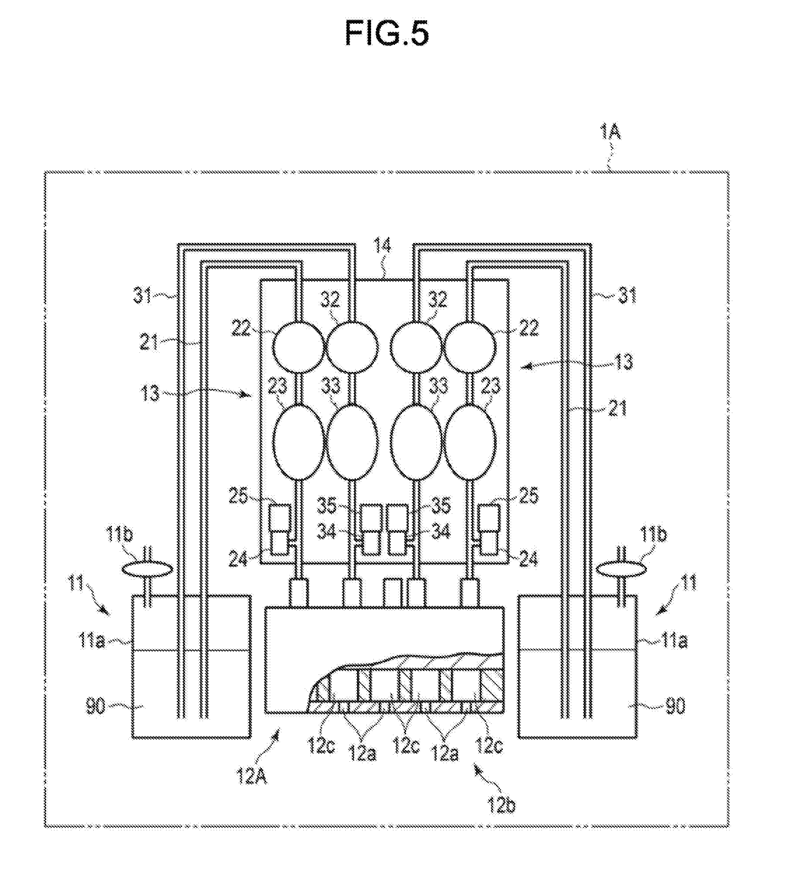

Hereinafter, an inkjet recording apparatus 1A using two ink circulation apparatuses 13 according to a second embodiment is described with reference to FIG. 4 to FIG. 5. In the configuration of the inkjet recording apparatus 1A according to the second embodiment, the components as those of the inkjet recording apparatus 1 according to the above-described first embodiment is denoted with the same reference numerals, and a detailed description thereof is omitted.

The inkjet recording apparatus 1A includes two tanks 11, a liquid discharge head 12A, two ink circulation devices 13 for circulating the ink 90 between the tank 11 and the liquid discharge head 12A, the casing 14, the CPU 15, the ROM 16, the RAM 17, the communication I/F 18, the head controller 19 and the control board 20.

Specifically, in the present embodiment, the inkjet recording apparatus 1A capable of circulating the ink 90 in two colors using the two ink circulation devices 13 to discharge the ink 90 is described.

The liquid discharge head 12A discharges the ink 90 in two colors. The liquid discharge head 12A has a plurality of nozzle rows 12b in which a plurality of nozzle holes 12a is arranged in one direction. In the liquid discharge head 12A, for example, a plurality of pressure chambers 12c of an actuator composed of a piezoelectric element and a vibration plate is arranged to face a nozzle plate having the nozzle row 12b, and by driving the actuator, the ink 90 in the pressure chamber 12c is discharged onto the image receiving medium from the nozzle hole 12a facing the pressure chamber 12c.

The liquid discharge head 12A has two independent ink flow paths for supplying the ink 90 to the respective pressure chambers 12c therein, and has a supply port arranged on the primary side of each ink flow path and a discharge port arranged at the secondary side of each ink flow path. In the liquid discharge head 12A, the ink flow paths are connected to the tank 11 and the ink circulation device 13, respectively.

The casing 14 accommodates two ink circulation devices 13 therein.

According to the inkjet recording apparatus 1A configured as described above, miniaturization can be realized with a simple configuration similarly to the inkjet recording apparatus 1 according to the first embodiment. In addition, the inkjet recording apparatus 1A is capable of discharging the ink 90 in two colors from the liquid discharge head 12A, and can accommodate the two ink circulation devices 13 in the casing 14 as well. Therefore, although the inkjet recording apparatus 1A can discharge the ink 90 in two colors, by providing a space capable of accommodating two tanks 11, only an installation space substantially the same as that of the inkjet recording apparatus 1 capable of discharging the ink 90 in one color is required, and thus, the miniaturization can be realized.

### Third Embodiment

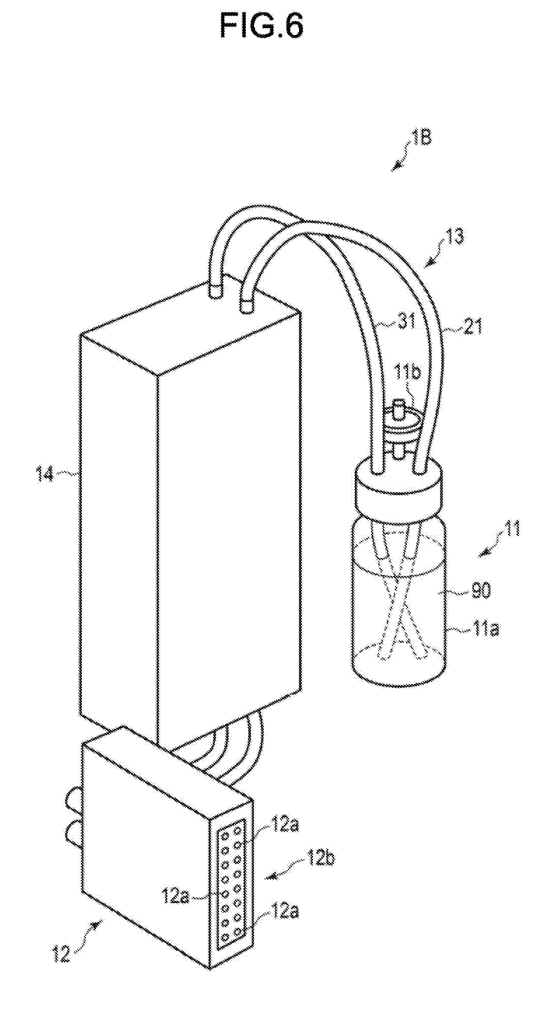

Hereinafter, an inkjet recording apparatus 1B using an ink circulation apparatus 13 according to a third embodiment is described with reference to FIG. 6. In the configuration of the inkjet recording apparatus 1B according to the third embodiment, the same components as those of the inkjet recording apparatus 1 according to the above-described first embodiment are denoted with the same reference numerals, and a detailed description thereof is omitted.

The inkjet recording apparatus 1B includes one tank 11, the liquid discharge head 12, one ink circulation device 13 for circulating the ink 90 between the tank 11 and the liquid discharge head 12, the casing 14, the CPU 15, the ROM 16, the RAM 17, the communication I/F 18, the head controller 19 and the control board 20.

The liquid discharge head 12 is arranged in a posture in which a plurality of nozzle holes 12a is open in a direction intersecting with the direction of gravity, for example, in a horizontal direction. For example, the liquid discharge head 12 is arranged in such a posture that a main surface direction of the nozzle plate extends along the direction of gravity and the plurality of nozzle holes 12a is aligned in the direction of gravity.

Specifically, the inkjet recording apparatus 1B has the same configuration as that of the inkjet recording apparatus in the above embodiment except that the posture of the liquid discharge head 12 is different from that of the liquid discharge head 12 of the inkjet recording apparatus 1 according to the above-described first embodiment.

According to the inkjet recording apparatus 1B configured as described above, the miniaturization can be realized with a simple configuration similarly to the inkjet recording apparatus 1 according to the first embodiment described above. In addition, according to the inkjet recording apparatus 1B, the ink can be discharged in an arbitrary direction by changing a posture of the liquid discharge head 12 from a posture in which the nozzle hole 12a opens towards the direction of gravity. For example, as shown in FIG. 6, if the liquid discharge head 12 is arranged in a posture in which the nozzle hole 12a opens towards the horizontal direction, the ink 90 can be laterally discharged, and a degree of freedom such as a posture or a conveyance direction of the image receiving medium can be improved.

Specifically, since the inkjet recording apparatus 1B is provided with the first diameter expansion portion 23 and the second diameter expansion portion 33, the inkjet recording apparatus 1B can control the pressure in the nozzle hole 12a using the first pump 22 and the second pump 32 without controlling the pressure of the ink 90 in the nozzle hole 12a by the hydraulic head pressure. Therefore, since the posture of the liquid discharge head 12 is not limited at the time of discharging the ink 90, the discharge direction of the ink 90 can be selected.

Specifically, by providing the first diameter expansion portion 23 and the second diameter expansion portion 33 for reducing the pulsation of the ink 90 respectively on the primary side and the secondary side of the liquid discharge head 12, the posture of the liquid discharge head 12 is not limited to the posture in which the nozzle hole 12a is open downwards in the direction of gravity. Therefore, as shown in FIG. 6, in a posture in which the nozzle hole 12a is open in the horizontal direction, the inkjet recording apparatus 1B can discharge the ink 90 laterally.

The present invention is not limited to the above embodiment without any change, and components thereof can be modified and embodied in a practical stage without departing from the spirit thereof.

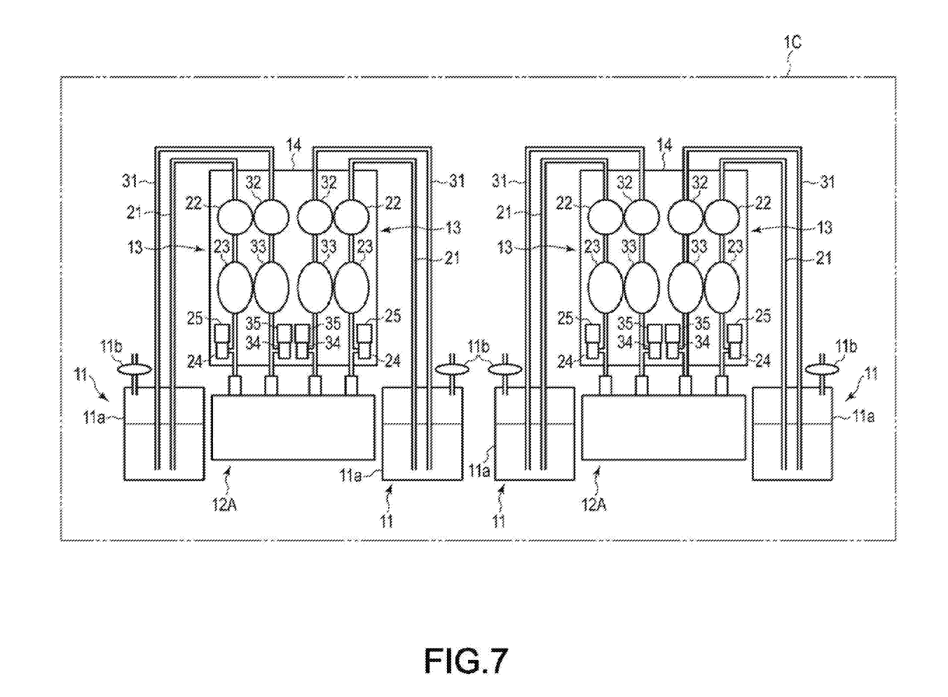

For example, in the above-described embodiments, one ink circulation device 13 is provided in the inkjet recording apparatuses 1 and 1B, and two ink circulation devices 13 are provided in the inkjet recording apparatus 1A; however, it is not limited thereto. For example, as shown in FIG. 7, in an inkjet recording apparatus 1C that discharges the ink 90 in four colors, four tanks 11, two liquid discharge heads 12A, four ink circulation devices 13 and two casings 14 may be provided.

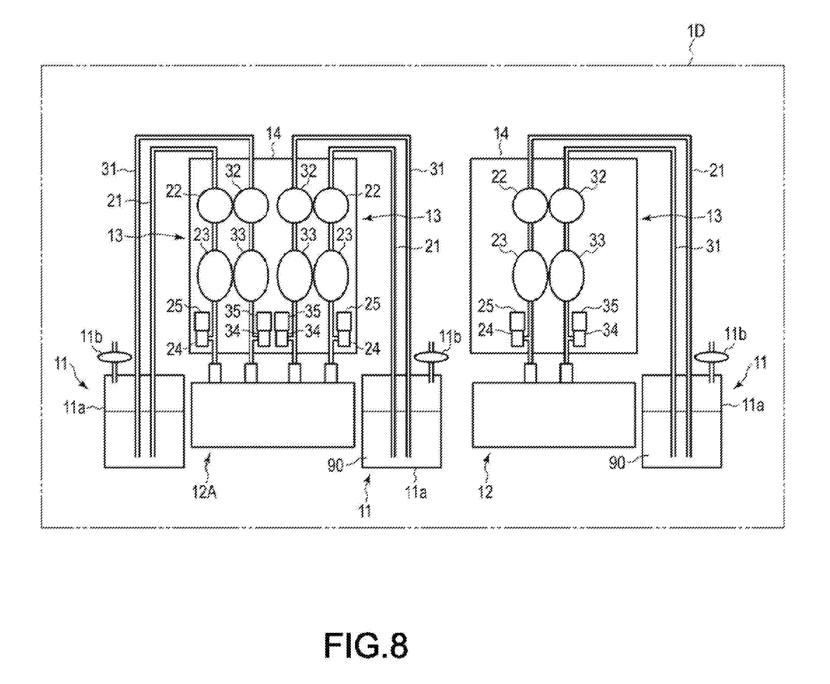

Similarly, as shown in FIG. 8, in an inkjet recording apparatus 1D that discharges the ink 90 in three colors, three tanks 11, the liquid discharge head 12, the liquid discharge head 12A, three ink circulation devices 13 and two casings may be provided. In other words, according to the color and type of the ink 90 to be used, it is possible to provide an inkjet recording apparatus capable of discharging various kinds of the ink 90 in plural colors by appropriately combining the respective configurations.

In the above examples, the tank 11 is provided; however, it is not limited thereto. In other words, since the ink circulation device 13 is provided with the first diameter expansion portion 23 and the second diameter expansion portion 33 each having a buffer function for reducing the pulsation of the ink 90 without using the hydraulic head pressure, the shape, the height position and a water level of the ink stored in the tank 11 are irrelevant, and no sub-tank is required. Therefore, the tank 11 may be any container prepared by the user.

In addition to the configuration of the inkjet recording apparatuses 1, 1A, 1B, 1C and 1D of the above-described embodiments, a moving mechanism for moving the liquid discharge head 12 may be provided. In addition to the configurations of the inkjet recording apparatuses 1, 1A, 1B, 1C and 1D of the above-described embodiments, a conveyance motor that conveys the image receiving medium, a carriage motor that controls the position of the liquid discharge head 12 and the like may be provided. The liquid used in the inkjet recording apparatuses 1, 1A, 1B, 1C and 1D is not limited to the ink 90, and the liquid discharge device for discharging a liquid other than the ink 90 may be used. As a liquid discharge device using the liquid other than the ink 90, for example, a device for discharging a liquid containing conductive particles for forming a wiring pattern of a printed wiring board or the like may be used.

The liquid discharge device may also be used in, for example, a 3D (three-dimensional) printer, an industrial manufacturing machine or the medical application. The actuator of the liquid discharge head 12 may deform the diaphragm electrically to change a volume of the pressure chamber 12c or may discharge the ink 90 from the nozzle using thermal energy from a heater or the like.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A liquid circulation device, comprising:
a first flow pipe;
a first pump arranged in communication with the first flow pipe;
a first diameter expansion portion, arranged in the first flow pipe on a secondary side of the first pump, having a larger cross sectional area than a cross sectional area of the first flow pipe;
a second flow pipe;
a second pump arranged in communication with the second flow pipe; and
a second diameter expansion portion, arranged in the second flow pipe on a primary side of the second pump, having a larger cross sectional area than a cross sectional area of the second flow pipe.

2. The liquid circulation device according to claim 1, further comprising:
a first pressure sensor, provided on a secondary side of the first diameter expansion portion coupled to the first flow pipe, configured to detect pressure of the first flow pipe;
a first valve, provided on a secondary side of the first diameter expansion portion in the first flow pipe, configured to open and close the first flow pipe;
a second pressure sensor, provided on a primary side of the second diameter expansion portion coupled to the second flow pipe, configured to detect pressure of the second flow pipe; and
a second valve, provided on a primary side of the second diameter expansion portion in the second flow pipe, configured to open and close the second flow pipe.

3. The liquid circulation device according to claim 1, further comprising:
a plurality of the first flow pipes, a plurality of the first pumps, a plurality of the first diameter expansion portions, a plurality of the second flow pipes, a plurality of the second pumps, and a plurality of the second diameter expansion portions.

4. The liquid circulation device according to claim 1, further comprising:
a first set of the first flow pipe, the first pump, the first diameter expansion portion, the second flow pipe, the second pump, and the second diameter expansion portion for a first type of ink; and
a second set of the first flow pipe, the first pump, the first diameter expansion portion, the second flow pipe, the second pump, and the second diameter expansion portion for a second type of ink.

5. The liquid circulation device according to claim 4, further comprising:
a third set of the first flow pipe, the first pump, the first diameter expansion portion, the second flow pipe, the second pump, and the second diameter expansion portion for a third type of ink.

6. The liquid circulation device according to claim 5, further comprising:
a fourth set of the first flow pipe, the first pump, the first diameter expansion portion, the second flow pipe, the second pump, and the second diameter expansion portion for a fourth type of ink.

7. A liquid discharge device, comprising:
a liquid discharge head comprising a plurality of nozzles for discharging ink;
a first flow pipe of which a secondary side is connected to the liquid discharge head;
a first pump arranged in communication with the first flow pipe;
a first diameter expansion portion, arranged in the first flow pipe on a secondary side of the first pump, having a larger cross sectional area than a cross sectional area of the first flow pipe;
a second flow pipe of which a primary side is connected to the liquid discharge head;
a second pump arranged in communication with the second flow pipe; and
a second diameter expansion portion, arranged in the second flow pipe on a primary side of the second pump, having a larger cross sectional area than that a cross sectional area of the second flow pipe.

8. The liquid discharge device according to claim 7, wherein
in the liquid discharge head, the plurality of nozzles opens in a direction intersecting with the direction of gravity.

9. The liquid discharge device according to claim 7, further comprising:
a first pressure sensor, provided on a secondary side of the first diameter expansion portion coupled to the first flow pipe, configured to detect pressure of the first flow pipe;
a first valve, provided on a secondary side of the first diameter expansion portion in the first flow pipe, configured to open and close the first flow pipe;
a second pressure sensor, provided on a primary side of the second diameter expansion portion coupled to the second flow pipe, configured to detect pressure of the second flow pipe; and
a second valve, provided on a primary side of the second diameter expansion portion in the second flow pipe, configured to open and close the second flow pipe.

10. The liquid discharge device according to claim 7, further comprising:
a plurality of the first flow pipes, a plurality of the first pumps, a plurality of the first diameter expansion portions, a plurality of the second flow pipes, a plurality of the second pumps, and a plurality of the second diameter expansion portions.

11. The liquid discharge device according to claim 7, further comprising:
a first set of the first flow pipe, the first pump, the first diameter expansion portion, the second flow pipe, the second pump, and the second diameter expansion portion for a first type of ink; and
a second set of the first flow pipe, the first pump, the first diameter expansion portion, the second flow pipe, the second pump, and the second diameter expansion portion for a second type of ink.

12. The liquid discharge device according to claim 11, further comprising:
a third set of the first flow pipe, the first pump, the first diameter expansion portion, the second flow pipe, the second pump, and the second diameter expansion portion for a third type of ink.

13. The liquid discharge device according to claim 12, further comprising:
a fourth set of the first flow pipe, the first pump, the first diameter expansion portion, the second flow pipe, the second pump, and the second diameter expansion portion for a fourth type of ink.

14. An image forming apparatus, comprising:
a liquid discharge head comprising a plurality of nozzles for discharging ink;
a first flow pipe of which a secondary side is connected to the liquid discharge head;
a first pump arranged in communication with the first flow pipe;
a first diameter expansion portion, arranged in the first flow pipe on a secondary side of the first pump, having a larger cross sectional area than a cross sectional area of the first flow pipe;
a second flow pipe of which a primary side is connected to the liquid discharge head;
a second pump arranged in communication with the second flow pipe; and
a second diameter expansion portion, arranged in the second flow pipe on a primary side of the second pump, having a larger cross sectional area than that a cross sectional area of the second flow pipe.

15. The image forming apparatus according to claim 14, wherein
in the liquid discharge head, the plurality of nozzles opens in a direction intersecting with the direction of gravity.

16. The image forming apparatus according to claim 14, further comprising:
a first pressure sensor, provided on a secondary side of the first diameter expansion portion coupled to the first flow pipe, configured to detect pressure of the first flow pipe;
a first valve, provided on a secondary side of the first diameter expansion portion in the first flow pipe, configured to open and close the first flow pipe;
a second pressure sensor, provided on a primary side of the second diameter expansion portion coupled to the second flow pipe, configured to detect pressure of the second flow pipe; and
a second valve, provided on a primary side of the second diameter expansion portion in the second flow pipe, configured to open and close the second flow pipe.

17. The image forming apparatus according to claim 14, further comprising:
a plurality of the first flow pipes, a plurality of the first pumps, a plurality of the first diameter expansion portions, a plurality of the second flow pipes, a plurality of the second pumps, and a plurality of the second diameter expansion portions.

18. The image forming apparatus according to claim 7, further comprising:
a first set of the first flow pipe, the first pump, the first diameter expansion portion, the second flow pipe, the second pump, and the second diameter expansion portion for a first type of ink; and
a second set of the first flow pipe, the first pump, the first diameter expansion portion, the second flow pipe, the second pump, and the second diameter expansion portion for a second type of ink.

19. The image forming apparatus according to claim 18, further comprising:
a third set of the first flow pipe, the first pump, the first diameter expansion portion, the second flow pipe, the second pump, and the second diameter expansion portion for a third type of ink.

20. The image forming apparatus according to claim 19, further comprising:
a fourth set of the first flow pipe, the first pump, the first diameter expansion portion, the second flow pipe, the second pump, and the second diameter expansion portion for a fourth type of ink.
